(19) United States
(12) Patent Application Publication
(10) Pub. No.: US 2008/0254187 A1
(43) Pub. Date: Oct. 16, 2008

(54) SEASONING HAVING FUNCTION OF IMPARTING KOKUMI TASTE

(75) Inventors: Kazuhiro Hayashi, Kawasaki-shi (JP); Mari Kojima, Kawasaki-shi (JP); Tomohiko Yamanaka, Kawasaki-shi (JP); Hirokazu Kawaguchi, Kawasaki-shi (JP); Hiroshi Tamura, Kawasaki-shi (JP); Naohiro Miyamura, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/860,810

(22) Filed: Sep. 25, 2007

Related U.S. Application Data
(63) Continuation of application No. PCT/JP2006/305903, filed on Mar. 17, 2006.

(30) Foreign Application Priority Data
Mar. 25, 2005 (JP) 2005-087485

(51) Int. Cl. A23L 1/22; A23L 2/52

(52) U.S. Cl. 426/590; 426/650

(57) ABSTRACT

The present application provides a taste-improving glycopeptide, a seasoning containing the same, and a food or drink containing the seasoning. The taste-improving glycopeptide of the present invention has a molecular weight of from 1,000 to 30,000 and is composed of a sugar chain and a peptide linked to each other.

### CROSS-REFERENCE TO RELATED APPLICATIONS

The present application is a continuation of PCT/JP2006/305903, filed on Mar. 17, 2006, which claims priority to Japanese Application No. JP 2005-087485, filed on Mar. 25, 2005, which are hereby incorporated by reference in their entirety.

### BACKGROUND OF THE INVENTION

1. Field of the Invention

The present invention relates to a taste-improving glycopeptide. In particular, the glycopeptide of the present invention imparts a kokumi taste. The present invention also relates to a seasoning containing the taste-improving glycopeptide as an active ingredient, as well as a food or drink seasoned with such a seasoning.

The seasoning of the present invention has an excellent kokumi taste, in particular a kokumi taste of a first taste and a middle taste. Therefore, the kokumi taste of a first taste and a middle taste of a food or drink seasoned with this seasoning is also enhanced. In other words, the present invention also provides a method of improving a kokumi taste of a food or drink. In this context, the kokumi taste of a first taste refers to a kokumi taste felt within 2 seconds from the time when a food is put in the mouth, while the kokumi taste of a middle taste refers to a kokumi taste felt between 2 to 4 seconds therefrom and the kokumi taste of an aftertaste refers to a kokumi taste felt after 4 seconds therefrom.

2. Discussion of the Background

Kokumi taste refers to a taste which cannot be expressed by the five basic tastes (a sweet taste, a salt taste, a sour taste, a bitter taste, and an umami taste). Kokumi taste includes not only basic tastes of thickness, spread, continuity, unity and the like, but also includes a taste obtained by enhancing tastes around or peripheral to the basic tastes. Heretofore, some methods for imparting a kokumi taste have been reported. These include methods wherein glutathione is added (Japanese Patent No. 1464928) and in which a glycopeptide is added (WO 2004/096836) to foods. However, in these conventional methods of imparting a kokumi taste, a kokumi taste centering an aftertaste can be imparted. None of the methods provided to date impart a kokumi taste of a first taste and a middle taste to a desired extent.

On the other hand, as a seasoning that imparts a kokumi taste of a first taste and a middle taste, a protein hydrolysate and the like can be exemplified. However, there exist problems with using a protein hydrolysate in that a different taste or an undesired flavor is also imparted due to impurities and the like.

Accordingly, there remains a critical need for safe, convenient, and reproducible methods of imparting a kokumi taste of a first taste and a middle taste. It is this need that the present invention addresses.

### SUMMARY OF THE INVENTION

In view of the problems heretofore existing in the art, it is an object of the present invention to provide a seasoning that can be more widely used in foods and drinks and has a strong effect of improving the tastes of the foods and drinks, thereby being capable of imparting a kokumi taste, in particular, a kokumi taste of a first taste and a middle taste.

The present inventors made intensive studies in order to achieve this object. As a result, the present inventors found a glycopeptide that has an excellent effect of imparting a kokumi taste of a first taste and a middle taste to a food or drink. Hereinafter, the finding will be described in detail.

In order to confirm the main body having an effect of imparting a kokumi taste of a first taste and a middle taste, the present inventors performed tracking and confirmation using seasonings having an extremely strong effect of imparting a kokumi taste of a first taste and a middle taste when added to a food or drink together with the judgment based on sensory evaluation.

First, with regard to selecting a starting raw material, the present inventors advanced confirmation using as a starting raw material, a seasoning having an extremely strong effect of imparting a kokumi taste of a first taste and a middle taste when added to a food or drink even in a small amount. More specifically, a seasoning obtained by hydrolyzing a raw material containing wheat protein by a koji mold was selected as a starting raw material.

As a result of intensive studies, the present inventors found that a fraction related to imparting of a kokumi taste of a first taste and a middle taste of the above-mentioned seasoning is a fraction having a molecular weight of from 1,000 to 30,000. That is, the present inventor confirmed that the fraction having a molecular weight of from 1,000 to 30,000 of the above-mentioned seasoning has a function of imparting of a kokumi taste of a first taste and a middle taste by various analyses and undergoing sensory evaluation. Further, the inventor revealed that it is necessary for imparting a kokumi taste of a first taste and a middle taste that a glycopeptide which has a molecular weight of from 1,000 to 30,000 and also is composed of a sugar chain and a peptide linked to each other is contained, and thus the present invention has been completed based on these findings.

As described above, the present invention relates to a seasoning, which has an effect of improving a taste, particularly an effect of imparting a kokumi taste, and more particularly an effect of imparting a kokumi taste of a first taste and a middle taste. The seasoning of the present invention preferably comprises, as an active ingredient, a glycopeptide which has a molecular weight of from 1,000 to 30,000 and is composed of a sugar chain and a peptide linked to each other. Further, the present invention provides a food or drink having an improved kokumi taste using the glycopeptide-containing fraction or seasoning of the present invention.

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in enzymology, biochemistry, cellular biology, molecular biology, and the food sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

The “glycopeptide” for use in the present invention and seasoning provide herein is a glycopeptide composed of a sugar chain and a peptide linked to each other. In this context, the sugar chain is not particularly limited with respect to the type of constituent sugar as long as it is composed of two or more sugars linked to each other. However, in the case where the sugar chain has a structure represented by the formula <I>, the effect of improving a taste is particularly increased. Thus, a glycopeptide having the structure represented by formula <I> represents a preferred embodiment of the present invention.

Further, the peptide is also not limited with respect to the type of constituent amino acid as long as it is composed of two or more amino acids linked to each other. However, in the case where it is composed of 5 or more amino acid residues, the effect of improving a taste is particularly increased.

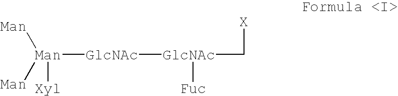

In Formula <I>, Man represents a mannose residue, Xyl represents a xylose residue, GlcNAc represents an N-acetylglucosamine residue, Fuc represents a fucose residue, and X represents a peptide residue.

The glycopeptide of the present invention may be synthesized or isolated from natural sources. For example, the glycopeptide can be obtained by hydrolyzing a raw material containing a vegetable protein such as wheat protein or soybean protein by a koji mold or an enzyme (protease or the like) and subjecting the resulting hydrolysate to separation and purification.

It is essential that the glycopeptide have a molecular weight of from 1,000 to 30,000 to exhibit the effect of imparting a kokumi taste of a first taste and a middle taste of the present invention. However, among those having a molecular weight of from 1,000 to 30,000, a glycopeptide having a molecular weight of from 3,000 to 30,000 has a strong effect of imparting a kokumi taste, and is preferred. The fraction having a molecular weight of from 1,000 to 30,000 containing the glycopeptide is not particularly limited with respect to the content for exhibiting an effect of imparting a kokumi taste in the raw material of the seasoning or the seasoning, and it may be a part in the seasoning or one obtained by purifying the fraction. However, when the content in the seasoning is preferably 1 ppm or more, more preferably 5 ppm or more, the effect of imparting a kokumi taste of the seasoning to a food or drink becomes evident. The upper limit of the concentration is not particularly limiting so long as the concentration does not contradict the purpose of the present invention (i.e., the content in the seasoning should not be at such a concentration that the effect of imparting a kokumi taste of a first taste and a middle taste is lost). Nonetheless, from the Examples set forth herein it is apparent that the upper concentration can be at least 100 ppm. Therefore, the content in the seasoning can be 1 ppm, 5 ppm, 10 ppm, 50 ppm, and 100 ppm, including all ranges and sub-ranges there between.

The raw material containing such a protein is not particularly limited as long as a hydrolysate thereof contains the above-mentioned glycopeptide and may be a starting raw material containing an arbitrary protein. Any protein, for example, a vegetable protein, an animal protein, a yeast cell-derived protein or the like can be used. Examples of the vegetable protein include seed proteins such as wheat protein, soybean protein and corn protein, and the like. Among them, in particular, an excellent effect of improving a kokumi taste is observed in a glycopeptide obtained from wheat protein or soybean protein.

As the enzyme to be used in the hydrolysis of protein according to the present invention, a naturally occurring enzyme which is metabolized with the use of a microorganism or the like, or a commercially available enzyme preparation can be used as long as it can enzymatically degrade a protein to be a raw material or a starting raw material containing such a protein. With regard to these enzymes, one type or plural types of enzymes may be appropriately used. The pH can be adjusted by adding an acid or an alkali which is allowed to be used in foods and drinks. The treatment time when a protein or a starting raw material containing a protein is treated by enzymatic hydrolysis varies depending on the conditions related to the hydrolysis such as the type of enzyme to be used for the hydrolysis of the protein, the amount of the enzyme to be used, the temperature, the pH, and the like. When the treatment time is much longer than necessary, unnecessary degradation or browning occurs or the like, and it may have an adverse effect on the quality in some cases, therefore, it is preferably 10 to 100 hours. A person skilled in the art can easily determine the hydrolysis conditions suitable for providing a glycoprotein having a predetermined molecular weight according to the present invention by appropriately sampling the hydrolysate during the hydrolysis treatment and then carrying out analysis or the like.

The seasoning containing a glycopeptide of the present invention can be obtained by collecting a liquid part of a hydrolysate of a protein hydrolyzed to a moderate degree by an enzyme with the use of a common method such as filtration or centrifugation. Such a seasoning can also be used as a purified seasoning by being subjected to a treatment such as decoloration, purification or concentration, for example, a decoloration treatment with the use of activated carbon, an ultrafilter or the like, a separation and purification treatment with various chromatographic techniques or membrane separation using a permeable membrane or the like, or a concentration treatment such as membrane concentration, vacuum concentration or the like. Further, the seasoning containing a glycopeptide of the present invention can be made in the form of a powder seasoning excellent in storage stability without adding table salt or the like if it is dried and powderized by a method such as spray-drying or vacuum freeze-drying.

Further, in the case where a high purity fraction having a molecular weight of from 1,000 to 30,000 containing a glycopeptide of the present invention is desired to be obtained, isolation and purification can be performed using a known separation and purification treatment method such as ultrafiltration, reverse osmosis membrane, dialysis membrane, normal phase HPLC, reversed phase HPLC, ion exchange chromatography, gel filtration chromatography or affinity chromatography from the above-mentioned protein hydrolysate or the above-mentioned glycopeptide-containing seasoning of the present invention.

The glycopeptide-containing seasoning of the present invention imparts a kokumi taste, in particular, a kokumi taste of a first taste and a middle taste to a food or drink and improving the taste of the whole food or drink without particularly adding an umami seasoning or the like by adding it to the food or drink.

There are a variety of foods such as soups, a variety of processed foods and the like with respect to the food in which an effect of improving a taste such as an effect of imparting a kokumi taste can be obtained by the glycopeptide-containing seasoning of the present invention. However, a more remarkable effect can be obtained particularly in a fermented seasoning, a fermented food, a food or drink using the same and the like, and a kokumi taste, in particular, a kokumi taste of a first taste and a middle taste can be imparted to these foods.

When the glycopeptide-containing seasoning of the present invention is added to a food, there is no restriction on a physical property such as a dry powder, a paste or a solution. Further, with regard to the addition thereof to a food or a seasoning, whenever it is added to a raw material, for example, before production, during production, after completion, immediately before eating, during eating, etc., an effect of imparting a kokumi taste can be obtained.

According to the present invention, a seasoning which can be more widely used in foods and drinks and has a strong effect of improving the tastes of the foods and drinks, thereby being capable of imparting a kokumi taste, in particular, a kokumi taste of a first taste and a middle taste can be provided.

The above written description of the invention provides a manner and process of making and using it such that any person skilled in this art is enabled to make and use the same, this enablement being provided in particular for the subject matter of the appended claims, which make up a part of the original description. Preferred embodiments of the invention are similarly fully described and enabled.

As used above, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

### Example 1

### Fractionation of Seasoning Containing Glycopeptide-Containing Fraction and Confirmation of Effect of Imparting Kokumi Taste

30 g of soybean protein “ESUSAN PROTEN F” (manufactured by J-Oil Mills Inc.) was added to 2 L of tap water and dispersed therein. The resulting mixture was heat-sterilized at 120° C. for 20 minutes resulting in a dispersion liquid of defatted soybean. A culture broth of Aspergillus oryzae pre-cultured in a culture medium was added thereto to give a final concentration of 1% (v/v). The mixture was cultivated in a fermentor jar at 30° C. for 36 hours. 500 g of wheat gluten “SWP-5A” (manufactured by Amylum) was added to 2 L of tap water and sufficiently dispersed therein, and the resulting mixture was sterilized by heating at 120° C. for 20 minutes to produce a dispersion liquid of wheat gluten. To 2 L of the prepared dispersion liquid of wheat gluten, 0.6 L of the above defatted soybean culture broth of Aspergillus oryzae was added as an enzyme source. The resulting mixture was hydrolyzed in a fermentor jar by maintaining the fermentor jar at 36° C. for 50 hours, while agitating with aeration. The thus-obtained hydrolysate liquid was subjected to solid-liquid separation using a Nutsche funnel, and 60 g of activated carbon was added to the filtrate. The resulting mixture was heated at 60° C. for 10 minutes to decolorize the filtrate and the activated carbon was removed from the decolorized liquid with a Nutsche funnel. The filtrate was lyophilized to produce a powdery enzymatically degraded wheat gluten seasoning.

The powdery enzymatically degraded wheat gluten seasoning was dissolved in water, and the resulting aqueous solution was ultrafiltered using an ultrafilter membrane “YM30” (manufactured by MILLIPORE Corporation). The collected liquid was further ultrafiltered using an ultrafilter membrane “YM1” (manufactured by MILLIPORE Corporation), whereby a fraction having a molecular weight of from 1,000 to 30,000 was obtained. Further, the obtained fraction was further ultrafiltered using an ultrafilter membrane “YM3” (manufactured by MILLIPORE Corporation), whereby a fraction having a molecular weight of from 3,000 to 30,000 was fractionated.

The fractions were subjected to an analysis by HPLC using a fluorescence detector based on a precolumn derivatization method. An enzymatic treatment using glycopeptidase A (manufactured by Seikagaku Kogyo Co., Ltd.) was conducted for 16 hours thereby cleaving the linkage between the sugar chain and the peptide. Then, the released sugar chain was fluorescently derivatized with 2-aminopyridine and subjected to HPLC analysis using a fluorescence detector. It was confirmed that the sugar chain is contained in the above fractions (a reference literature for conditions of derivatization and analysis: Agric. Biol. Chem., 54(8), 2169-2170, 1990).

In order to confirm a function of imparting a kokumi taste of the glycopeptide-containing fractions, each of the obtained two fractions was added to a commercially available beef extract (manufactured by Bordon) such that the concentration thereof upon eating becomes 0.1 ppm to 100 ppm. By using a beef extract without addition thereof as a control, sensory evaluation was carried out by 15 taste panelists. The results are shown in the following Table 1.

TABLE 1

| Molecular weight: 1,000 to 30,000 | | | Molecular weight: 3,000 to 30,000 | | |
|---|---|---|---|---|---|
| | | Glycopeptide- | | | Glycopeptide- |
| | | containing | | | containing |
| | | fraction | | | fraction |
| 0.1 | ppm | X | 0.1 | ppm | Δ |
| 0.5 | ppm | Δ | 0.5 | ppm | ◯ |
| 1 | ppm | ◯ | 1 | ppm | ◯◯ |
| 5 | ppm | ◯◯ | 5 | ppm | ◯◯ |
| 10 | ppm | ◯◯ | 10 | ppm | ◯◯ |
| 50 | ppm | ◯◯ | 50 | ppm | ◯◯ |
| 100 | ppm | ◯◯ | 100 | ppm | ◯◯ |

In Table 1, the symbols have the following meaning:
X: not higher than the control;
Δ: the same as the control;
◯: a kokumi taste of a first taste and a middle taste is stronger than the control; and
◯◯: a kokumi taste of a first taste and a middle taste is apparently stronger than the control.

As is understood from Table 1, an effect of imparting a kokumi taste is evident at 1 ppm or more. It is also evident that the effect is more preferred in the fraction having a molecular weight of from 3,000 to 30,000 than the fraction having a molecular weight of from 1,000 to 30,000.

### Example 2

### Comparison of Functions Between the Glycopeptide-Containing Fraction of the Present Invention and a Known Glycopeptide

In order to confirm the difference in the effect of imparting a kokumi taste between the glycopeptide-containing fraction having a molecular weight of from 1,000 to 30,000 obtained in Example 1 (the present invention) and a glycopeptide having a structure represented by the following sequence formula (II) disclosed in WO 2004/096836, each of these substances were added to a commercially available beef extract (manufactured by Bordon) such that the concentration thereof becomes 1 ppm. By using a beef extract without addition thereof as a control, sensory evaluation was carried out by 16 taste panelists.

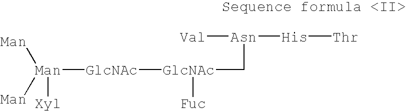

With regard to the evaluation points, evaluation was carried out in terms of feeling a kokumi taste in a first taste, a middle taste or an aftertaste. A kokumi taste felt in 2 seconds, 4 seconds and 6 seconds after a tasting solution was put in the mouth was determined to be a kokumi taste of a first taste, a kokumi taste of a middle taste, and a kokumi taste of an aftertaste, respectively. The results are shown in the following Table 2.

TABLE 2

| | Kokumi taste of | | Kokumi taste of | | Kokumi taste of | |
|---|---|---|---|---|---|---|
| | first taste | | middle taste | | aftertaste | |
| | Glyco- | Present | Glyco- | Present | Glyco- | Present |
| | peptide | invention | peptide | invention | peptide | invention |
| Kokumi | 0 | 16*** | 6 | 10 | 15*** | 1 |
| taste is | | | | | | |
| stronger | | | | | | |

(***Significance level of 0.1%,
**Significance level of 1%,
*Significance level of 5%)

From Table 2, it was determined that the present invention has an effect of imparting a kokumi taste of a first taste and a middle taste, which is different from WO 2004/096836 having an effect of imparting a kokumi taste of an aftertaste.

### Example 3

### Comparison of Functions Between Presence and Absence of Glycopeptide-Containing Fraction (the Present Invention

Two types of commercially available hydrolyzed vegetable protein seasonings (A and B) were fractionated by the same fractionation method as in Example 1 (it was confirmed that a sugar chain is not contained in the commercially available seasonings). Subsequently, each fraction was added to a beef extract to give a final concentration of 1 ppm or 5 ppm in the same manner as in Example 1. Then, sensory evaluation was carried out by 20 taste panelists by the pair test in terms of an effect of imparting a kokumi taste in a first taste and a middle taste in the same manner as in Example 2. The results are shown in the following Table 3.

TABLE 3

| | | | |
|---|---|---|---|
| Commercially | | Commercially | |
| available | | available | |
| seasoning | Present | seasoning | Present |
| A | invention | B | invention |

Addition at 1 ppm

| | | | | |
|---|---|---|---|---|
| Kokumi | 3 | 17** | 2 | 18*** |
| taste is | | | | |
| stronger | | | | |

Addition at 5 ppm

| | | | | |
|---|---|---|---|---|
| Kokumi | 1 | 19** | 1 | 19*** |
| taste is | | | | |
| stronger | | | | |

(***Significance level of 0.1%,
**Significance level of 1%,
*Significance level of 5%)

From Table 3, it was determined that the presence of the sugar chain-containing fraction is important for the expression of a kokumi taste of a first taste and a middle taste.

### Example 4

### Effect of Imparting Kokumi Taste to Consomme Soup

In order to verify an effect of improving a taste of a consomme soup (a 2% solution) in the same manner as the sensory evaluation in Example 1, a glycopeptide-containing fraction having a molecular weight of from 1,000 to 30,000 obtained by the method of Example 1 was added to a commercially available consomme soup (manufactured by Ajinomoto Co., Inc.) to give a final concentration of 10 ppm or 50 ppm. By using a consomme soup without addition thereof as a control, sensory evaluation was carried out by 16 taste panelists by the pair test. The results are shown in the following Table 4.

TABLE 4

| | |
|---|---|
| | Addition of glycopeptide- |
| Without addition | containing fraction |

Addition at 10 ppm

| | | |
|---|---|---|
| Kokumi taste is | 2 | 14** |
| stronger | | |
| Comment | | A kokumi taste of a first |
| | | taste and a middle taste is |
| | | imparted thereby to provide |
| | | a rich taste. |

Addition at 50 ppm

| | | |
|---|---|---|
| Kokumi taste is | 1 | 15*** |
| stronger | | |
| Comment | | A kokumi taste of a first |
| | | taste and a middle taste is |
| | | imparted thereby to provide |
| | | a rich taste. |

(***Significance level of 0.1%,
**Significance level of 1%,
*Significance level of 5%)

From Table 5, it was determined that the present invention also has a remarkable effect of imparting a kokumi taste of a first taste and a middle taste to a food.

### Example 5

### Effect of Imparting Kokumi Taste to Home-Made Dashi (Soup Stock) Extract

In order to verify an effect of improving a taste of a home-made dashi (soup stock) extract in the same manner as the sensory evaluation in Example 1, a glycopeptide-containing fraction having a molecular weight of from 3,000 to 30,000 obtained by the method of Example 1 was added to a home-made dashi (soup stock) extract prepared by the preparation method shown in the following Table 5 to give a final concentration of 1 ppm or 5 ppm. By using a home-made dashi (soup stock) extract without addition thereof as a control, sensory evaluation was carried out by 16 taste panelists by the pair test. The results are shown in the following Table 6.

TABLE 5
Preparation method of home-made dashi (soup stock) extract

| 5% Natural katsuo (bonito) | 5% Natural katsuo (bonito) |
|---|---|
| dashi (Atsu Kezuri (thicker | dashi (Hana Katsuo (dried |
| slices of dried bonito)) | bonito flakes)) |
| <Preparation method> | <Preparation method> |
| Add 5% by weight of Hon katsuo | Add 5% by weight of Hana Katsuo |
| Atsu Kezuri W.I. (available | Aka (available from Igarashi |
| from Igarashi Katsuobushi-ten) | Katsuobushi-ten) to boiling |
| to boiling water | water |
| ↓ | ↓ |
| Perform extraction of | After adding the bonito flakes, |
| dashi for 45 minutes | turn the stove off, and let the |
| while boiling the | mixture stand until the bonito |
| mixture slightly | flakes go down to the bottom. |
| ↓ | ↓ |
| Put a paper towel on a colander | Put a paper towel on a colander |
| and pour the extraction liquid | and pour the extraction liquid |
| through the colander. | through the colander. |
| ↓ | ↓ |
| Adjust the water content | Adjust the water content to make |
| tomake the yield 100%. | the yield 100%. |

The above-mentioned dashi stocks are mixed such that the ratio of Atsu Kezuri dashi to Hana Katsuo dashi is 70% to 30%.

TABLE 6

| | |
|---|---|
| Without | |
| addition | Addition of glycopeptide-containing fraction |

Addition at 1 ppm

| | | |
|---|---|---|
| Kokumi taste is | 3 | 13* |
| stronger | | |
| Comment | | A kokumi taste of a first taste and a middle |
| | | taste is imparted. |

Addition at 5 ppm

| | | |
|---|---|---|
| Kokumi taste is | 2 | 14** |
| stronger | | |
| Comment | | A kokumi taste of a first taste and a middle |
| | | taste is imparted. |

(***Significance level of 0.1%,
**Significance level of 1%,
*Significance level of 5%)

From Table 6, it was determined that the present invention also has a remarkable effect of imparting a kokumi taste of a first taste and a middle taste to a food.

### Example 6

### Fractionation of Seasoning Containing Glycopeptide-Containing Fraction (Derived from Soybean) and Confirmation of Effect of Imparting Kokumi Taste

60 kg of expanded defatted soybean and 47 kg of a culture broth of L. lactis AJI10212 (FERM BP-8552) (pH 6.3) were put in a mixer (“mazelar” (manufactured by Sangyo Kikai Co. Ltd.)), and mixed sufficiently. Then, the spores of A. sojae AJI17552 (FERM P-19637) were added thereto at 2×10⁶ spores/g of raw material and mixed. The resulting mixture was placed in a ventilation koji producing apparatus, and cultivated for 45 hours while maintaining the temperature of the mixture at 30 to 32° C. Then, 40 kg of the obtained koji and 108 kg of a salt solution with a salt concentration of 15.6% by weight were put in a tank with a jacket. As the salt, “Nakuru M” (manufactured by Naikai Salt Industries Co., Ltd.) was used.

Moromi was heated by circulating hot water in the jacket portion, and fermentation was performed at 35° C. for 14 days. Further, the mixture was mixed once a day during fermentation, whereby koji floating in the upper area was uniformly dispersed. After completion of the fermentation, the residue was removed with a filter cloth, whereby Namaage was obtained. To 1 L of the resulting Namaage, 40 g of table salt and 20 g of 95% alcohol (manufactured by Japan Alcohol Corporation) were added, and then the pH of the Namaage was adjusted to 4.5 with 6 N hydrochloric acid. To 200 g of Namaage after the pH adjustment, 0.04 g of activated carbon “SD-V6 carbon” (manufactured by Ajinomoto Fine-Techno Co., Inc.) was added (at 0.02% relative to Namaage), and the mixture was incubated at 30° C. for 120 minutes. Then, the pH of the mixture was adjusted to 5.1 with 40% NaOH, and filtration was conducted twice through a filter paper of “No. 2” and then, a filter paper of “No. 5C” (manufactured by Advantec) to remove activated carbon. Subsequently, the obtained clear Namaage was heated at 80° C. for 30 minutes, and then left at 60° C. for 24 hours to promote coagulation of sediment. Finally, centrifugation was performed to obtain a supernatant, and the supernatant was filtered (0.45 μm, Chromatodisk (manufactured by Kurabo Industries Ltd.), whereby a clear enzymatically degraded defatted soybean protein seasoning was obtained.

The thus obtained enzymatically degraded defatted soybean protein seasoning was ultrafiltered by the same method as in Example 1, and fractions having a molecular weight of from 1,000 to 30,000 and a molecular weight of from 3,000 to 30,000 were fractionated. It was confirmed that the obtained fractions contain a sugar chain by the HPLC method described in Example 1.

In order to confirm a function of imparting a kokumi taste of the glycopeptide-containing fraction derived from soybean protein, sensory evaluation was carried out by 15 taste panelists by an evaluation method using a beef extract in the same manner as in Example 1. The results are shown in Table 7.

TABLE 7

| Molecular weight: 1,000 to 30,000 | | | Molecular weight: 3,000 to 30,000 | | |
|---|---|---|---|---|---|
| | | Glycopeptide- | | | Glycopeptide- |
| | | containing | | | containing |
| | | fraction | | | fraction |
| 0.1 | ppm | X | 0.1 | ppm | Δ |
| 0.5 | ppm | Δ | 0.5 | ppm | ◯ |
| 1 | ppm | ◯ | 1 | ppm | ◯◯ |
| 5 | ppm | ◯◯ | 5 | ppm | ◯◯ |
| 10 | ppm | ◯◯ | 10 | ppm | ◯◯ |
| 50 | ppm | ◯◯ | 50 | ppm | ◯◯ |
| 100 | ppm | ◯◯ | 100 | ppm | ◯◯ |

In Table 7, the symbols have the following meaning:
X: not higher than the control;
Δ: the same as the control;
◯: a kokumi taste of a first taste and a middle taste is stronger than the control; and
◯◯: a kokumi taste of a first taste and a middle taste is apparently stronger than the control.

As is understood from Table 7, an effect of imparting a kokumi taste is evident at 1 ppm or more. It is also evident that the effect is more preferred in the fraction having a molecular weight of from 3,000 to 30,000 than the fraction having a molecular weight of from 1,000 to 30,000.

Numerous modifications and variations on the present invention are possible in light of the above teachings. It is, therefore, to be understood that within the scope of the accompanying claims, the invention may be practiced otherwise than as specifically described herein.

1. A seasoning comprising a glycopeptide having a molecular weight of from 1,000 to 30,000 and is composed of a sugar chain and a peptide linked to each other.

2. The seasoning according to claim 1, wherein said glycopeptide is composed of 5 or more amino acid residues.

3. The seasoning according to claim 1, wherein said sugar chain has a structure represented by formula <I>: 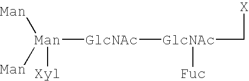
wherein Man represents a mannose residue, Xyl represents a xylose residue, GlcNAc represents an N-acetylglucosamine residue, Fuc represents a fucose residue, and X represents a peptide residue.

4. The seasoning according to claim 3, wherein said glycopeptide represented by formula <I> has a molecular weight ranging from 3,000 to 30,000.

5. The seasoning according to claim 1, wherein said glycopeptide is in the form of a hydrolysate of a vegetable protein by a koji mold.

6. The seasoning according to claim 1, wherein said glycopeptide is an enzymatic hydrolysate of wheat gluten.

7. The seasoning according to claim 1, wherein said glycopeptide is an enzymatic hydrolysate of defatted soybean.

8. The seasoning according to claim 1, wherein the content of said glycopeptide in said seasoning is at least 1 ppm.

9. The seasoning according to claim 8, wherein the content of said glycopeptide in said seasoning is less than 100 ppm.

10. A food or drink, comprising the seasoning according to claim 1.

11. The food or drink according to claim 10, wherein said glycopeptide is composed of 5 or more amino acid residues.

12. The food or drink according to claim 10, wherein said sugar chain has a structure represented by formula <I>: 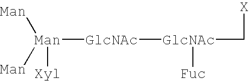
wherein Man represents a mannose residue, Xyl represents a xylose residue, GlcNAc represents an N-acetylglucosamine residue, Fuc represents a fucose residue, and X represents a peptide residue.

13. The food or drink according to claim 12, wherein said glycopeptide represented by formula <I> has a molecular weight ranging from 3,000 to 30,000.

14. The food or drink according to claim 10, wherein said glycopeptide is in the form of a hydrolysate of a vegetable protein by a koji mold.

15. The food or drink according to claim 10, wherein said glycopeptide is an enzymatic hydrolysate of wheat gluten.

16. The food or drink according to claim 10, wherein said glycopeptide is an enzymatic hydrolysate of defatted soybean.

17. The food or drink according to claim 10, wherein the content of said glycopeptide in said seasoning is at least 1 ppm.

18. The food or drink according to claim 17, wherein the content of said glycopeptide in said seasoning is less than 100 ppm.
